(19) United States
(12) Patent Application Publication
(10) Pub. No.: US 2025/0075055 A1
(43) Pub. Date: Mar. 6, 2025

(54) CHEMICAL CONVERSION OF POLYURETHANES UNDER MILD CONDITIONS

(71) Applicant: Lawrence Livermore National Security, LLC, Livermore, CA (US)

(72) Inventors: Sijia Huang, Dublin, CA (US); Benjamin Martin Alameda, Livermore, CA (US); Wei-Shan Huynh, Carlsbad, CA (US); Adam Jacob Carleton, Livermore, CA (US)

(21) Appl. No.: 18/816,940

(22) Filed: Aug. 27, 2024

Related U.S. Application Data
(60) Provisional application No. 63/535,220, filed on Aug. 29, 2023.

(51) Int. Cl. C08J 11/24; C08G 18/32; C08G 75/045

(52) U.S. Cl. CPC C08J 11/24; C08G 18/3206; C08G 75/045; C08J 2375/04

(57) ABSTRACT

A product includes a mixture for converting a polyurethane where the mixture includes a functional alcohol and a catalyst. A method of converting polyurethane includes forming a mixture at an ambient temperature where the mixture includes a polyurethane, a functional alcohol, and a catalyst. The method further includes collecting a product from the mixture after a duration of time. The product includes a diallyl urethane monomer and a multi-functional alcohol.

### RELATED APPLICATIONS

This application claims priority to Provisional U.S. Appl. No. 63/535,220 filed on Aug. 29, 2023, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to polyurethane material, and more particularly, this invention relates to chemical conversion of polyurethanes for recycling the same under mild conditions to monomer by-products.

### BACKGROUND

Polyurethanes are major consumer plastic materials with an estimated global market size of USD 91 billion by 2026, ranking 7th in global plastics production with an annual production of 27 million tons in 2015. In particular, due to their superior mechanical properties, polyurethane polymers are ubiquitous and have been extensively used for a wide range of applications.

While PU is ubiquitous for high-end durable goods due to their superior mechanical properties, PU recycling is impractical due to the lowered values associated with the processes or repurposed PU materials. At present, there are numerous difficulties associated with reprocessing and/or repurposing these materials. Less than 20% of polyurethanes, mainly polyurethane thermoplastics, are recycled by rebonding, adhesive pressing, and glycolysis. The dissociative reversion of carbamate bonds to isocyanates and alcohols has been studied since around the same time that polyurethanes were first synthesized back in the 1930s. This dissociative reaction occurs at high temperatures (−200° C.), which generally leads to deleterious side reactions.

Interestingly, incorporating dynamic covalent bonds into polymer networks is an attractive strategy for the design of recyclable materials. Unfortunately, recycling of polyurethanes is still an infeasible process, at least through the transcarbamate reaction. To date, most recyclable and reprocessable polyurethane systems rely on remolding processes, which generally require high temperature, metal catalysts, and suffer from a reduction in mechanical properties of the recycled materials relative to the pristine materials. For example, for recycling polyurethane, polyurethane is mixed with ethylene glycol at a very high temperature (about 200° C. and higher) and high pressure to degrade the polyurethane. The process is not economically feasible because of the harsh conditions involved. The process to overcome these limitations remains elusive despite attempts to determine an appropriate catalyst, insertion of other dynamic chemistries, and alternative polymerization methods.

### SUMMARY

In one aspect, a product includes a mixture for converting a polyurethane where the mixture includes a functional alcohol and a catalyst.

In another aspect, a method of converting polyurethane includes forming a mixture at an ambient temperature where the mixture includes a polyurethane, a functional alcohol, and a catalyst. The method further includes collecting a product from the mixture after a duration of time. The product includes a diallyl urethane monomer and a multi-functional alcohol.

In yet another aspect, a photopolymer includes a thiol-ene network that includes urethane linkages.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic diagram of a method of conversion of polyurethanes for chemical recycling of components, according to one aspect.

FIG. 2 is a flow chart of a method, according to one aspect.

FIG. 3 is a schematic diagram of a chemical recycling reaction, according to one aspect.

FIG. 4 depicts NMR spectrums of the products of a reaction, according to one aspect. Part (a) diallyl urethane monomer, and part (b) multi-functional alcohol.

FIG. 5 is a plot of the conversion of depolymerized urethane monomers, according to one aspect.

FIG. 6 depicts images of three-dimensional printed parts using depolymerized urethane monomers, according to one aspect. Part (a) depicts a gyroid-type structure, and part (b) depicts a structure having a predefined arrangement of struts.

FIG. 7A is a plot of the mechanical strength of recycled urethane photopolymers, according to one aspect.

FIG. 7B is a plot of the toughness versus Young's Modulus of recycled urethane-thiol-ene photopolymers compared to conventional thiol-ene photopolymers, according to one aspect.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred embodiments of a chemical conversion of polyurethanes under mild conditions and/or related systems and methods.

In one general aspect, a product includes a mixture for converting a polyurethane where the mixture includes a functional alcohol and a catalyst.

In another general aspect, a method of converting polyurethane includes forming a mixture at an ambient temperature where the mixture includes a polyurethane, a functional alcohol, and a catalyst. The method further includes collecting a product from the mixture after a duration of time. The product includes a diallyl urethane monomer and a multi-functional alcohol.

In yet another general aspect, a photopolymer includes a thiol-ene network that includes urethane linkages.

A list of acronyms used in the description is provided below.
3D three-dimensional
AM additive manufacturing
C Celsius
PU polyurethane
t-BuOK tert-butoxide
wt. % weight percent

In additive manufacturing applications, urethane-containing methacrylates have been widely used to improve mechanical properties in ductility, toughness, and elasticity. Hence, various aspects described herein focus on chemical converting polyurethane wastes for additive manufacturing feedstock (e.g., upgrading polyurethane in order to recycle by-products of depolymerized polyurethanes). It has been desirable in manufacturing industry to be able to degrade polyurethanes under mild conditions, for example, at room temperature, with no additional pressure, etc. As described herein, various aspects demonstrate that crosslinked polyurethane wastes may be readily depolymerized to liquid monomers at ambient temperature. The resultant monomers are suitable for construction of thiol-ene photopolymer networks which can be implemented in additive manufacturing.

In contrast to prior work with monofunctional alcohols, aspects disclosed herein utilize functional alcohol to depolymerize polyurethane crosslinked network. The process as described herein is able to upcycle polyurethane material into a high yield of products using a functional alcohol and catalyst at ambient temperatures, ideally without any added heat and without any added pressure. Moreover, it was surprising that a functional alcohol, such as an allyl alcohol, could degrade polyurethane at room temperature and with no additional pressure. Some functional alcohols, such as allyl alcohol, are typically used for organic reactions as a building block for organic synthesis. For example, allyl alcohols may be used in synthesizing monomer products. Allyl alcohols are not known to be used for degradation of a commodity polymer into a useful monomer.

Moreover, the functional alcohol, e.g., allyl alcohol, propargyl alcohol shows a five times increase in the depolymerization efficiency compared with current state of art (e.g., methanol, ethylene glycol). In conventional degradation systems with monofunctional alcohols (methanol, ethylene glycol, etc.) the yield of degraded urethane products is typically 18% to 30% under ambient conditions. However, using functional alcohols such as allyl alcohol to degrade polyurethane generates a yield greater than 70%.

Moreover, the process as described herein yield direct products that may be used as generated and may not need any further synthesis methods. The mixture of monomer by-products may include further processing steps to separate the two by-products from the product mixture before being used applications, e.g., in photopolymerization methods. In sharp contrast, conventional recycling methods typically include continued processing of the degradation products to synthesize a useful product for further use. The conventional method can only reclaim a polyol from the degradation method, but cannot reclaim a by-product for photopolymerization processes.

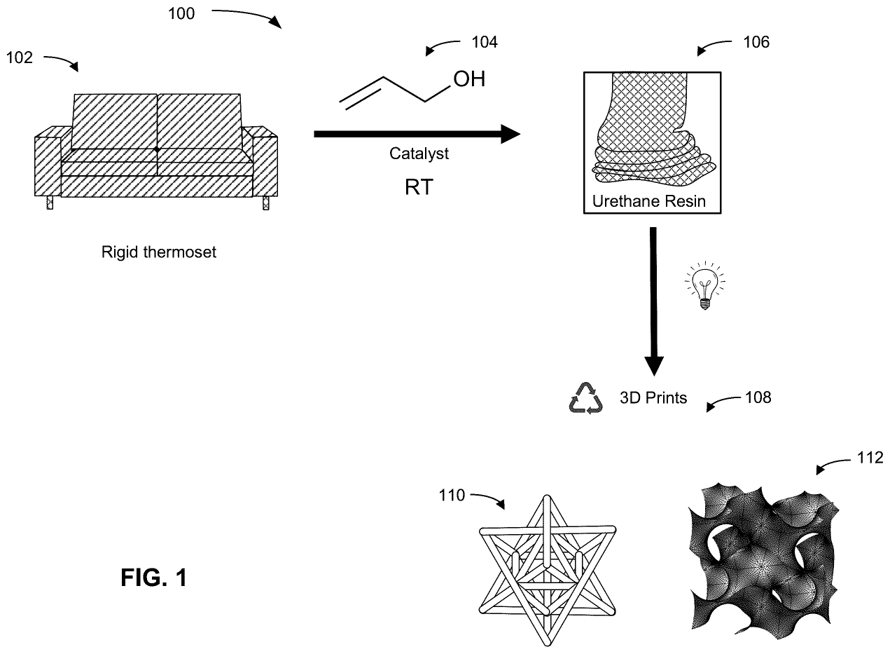

In one example of an aspect of the invention, the schematic diagram in FIG. 1 illustrates a process 100 of upcycling a rigid thermoset polyurethane material 102 with a functional alcohol 104 at ambient conditions (e.g., RT) to form a urethane resin 106. The urethane resin 106 may then be combined with a co-monomer to form a three-dimensional (3D) product(s) 108 having a complex shape, thereby recycling the rigid thermoset 102 into a new product 108 having superior mechanical strength. In one example, the new product 108 may be a complex shape 110 having ligaments, filaments, etc. arranged in a complex geometric arrangement. In another example, the new product 108 may have a gyroid shape 112, a complex shape having a optimal surface area.

According to one aspect, a functional alcohol may depolymerize urethane at ambient temperature followed by a simple purification step to separate the two by-products, the multi-functional alcohol and the urethane “resin” (e.g., diallyl urethan monomer). However, for each by-product, no additional cleaning procedure of the separated by-product is needed to purify the depolymerized by-products. Moreover, the functional alcohol in a reaction with polyurethane generates a high yield of an end product that is useful for three-dimensional (3D) printing. For example, an allyl alcohol reacts with polyurethane to form a high yield of a diallyl urethane monomer. In various approaches, converting polyurethane material may be useable for upgrading polyurethane (i.e., converting the polyurethane molecules) in to useable end products such as a diallyl urethane monomer and a multi-functional alcohol.

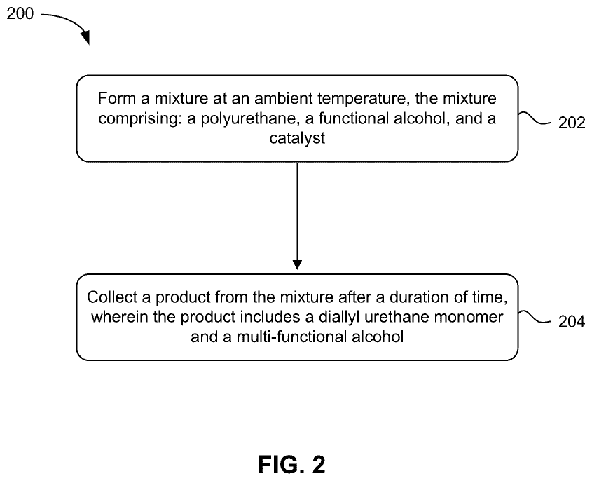

FIG. 2 shows a method 200 for converting polyurethane to secondary products, in accordance with one aspect of one inventive aspect. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative aspects listed herein. Further, the methods presented herein may be carried out in any desired environment. Moreover, more or less operations than those shown in FIG. 2 may be included in method 200, according to various aspects. It should also be noted that any of the aforementioned features may be used in any of the aspects described in accordance with the various methods.

Method 200 begins with operation 202 that includes forming a mixture at an ambient temperature. In various approaches, the mixture includes a polyurethane, a functional alcohol, and a catalyst. In preferred approaches, the method does not include adding heat to the mixture (except perhaps to raise the temperature of the mixture to room temperature, as defined above, but not above room temperature). Ambient temperature in preferred aspects may be defined as room temperature. Likewise, in preferred approaches, the method does not include added pressure.

In some approaches, a product includes a mixture for converting a polyurethane to useable by-products may include a functional alcohol and a catalyst. The mixture may be configured to convert a polyurethane having at least one urethane linkage. In one approach, a mixture for converting a polyurethane to useable by-product consists essentially of a functional alcohol and a catalyst such that the mixture may include additives that do not materially affect the basic conversion reaction of the polyurethane into useable by-products. In another approach, the mixture for converting a polyurethane to useable by-products consists of a functional alcohol and a catalyst, and does not include any other component. The mixture may be added to a polyurethane, where the polyurethane includes at least one urethane linkage. The mixture may be characterized as causing a reaction with the polyurethane upon addition of the mixture to the polyurethane to thereby form a secondary product that includes a diallyl urethane monomer and a multi-functional alcohol.

In some aspects, the functional alcohols include at least one —OH group, where the product includes instructions to add an amount of the mixture to the polyurethane such that the functional alcohol is present in molar excess of the number of urethane linkages of the polyurethane. In various approaches, the functional alcohol may include at least one of the following: allyl alcohol, propargyl alcohol, glycidol, allyl amine, propargylamine, etc. Alcohols such as functional alcohols with photochemical handles, e.g., (hydroxyethyl)methacrylate, (hydroxyethyl)acrylate, etc. tend not to be as efficient as the allyl alcohol because of stability issues of the functional alcohol.

In preferred approaches, the catalyst is a base catalyst. The selection of base catalyst has a strong effect on the reaction yield. The catalyst is configured to react with the polyurethane for accelerating the reaction of the functional alcohol with the polyurethane to form secondary products. The base catalyst provides the basic environment for the reaction. Without the base catalyst, depolymerization cannot happen. According to some approaches, the catalyst includes a strong base. The stronger base allows a higher reaction yield. For example, a high reaction yield may be based on the following order of base catalysts: CsCO₃<K₂CO₃<KOH<NaOH<t-BuOK. The base catalyst may include NaOH, KOH, K₂CO₃, NaCO₃, tert-butoxide (t-BuOK), t-BuONa, etc.

In one approach, the polyurethane may be a rigid polyurethane material, for example, a rigid polyurethane foam. A polyurethane foam is to some extent rigid but tends to be resiliently deformable (returns to its original shape). A polyurethane coating (e.g., on a surface, etc.) has little to no deformability, elasticity, etc., and may break under strain. The rigidity or elasticity of the polyurethane may be defined in terms of relative strain at break values. For example, highly flexible polyurethane elastomers may exhibit strains greater than 100% or rigid polyurethanes foams with little to no elasticity (<10% strain). In some approaches, a polyurethane material has a modulus of elasticity of at least 10%. In some approaches, polyurethane material is not resiliently deformable, e.g., tends to become deformed and/or break along a seam of bending upon the polyurethane material being folded over upon itself. In other approaches, polyurethane may include flexible polyurethane foam, polyurethane coatings, polyurethane sprays, etc.

In one approach, the polyurethane may include an aromatic isocyanate-based urethane. The aromatic groups of the polyurethane, e.g., a polyurethane comprised of aromatic isocyanates, are essential for the reaction with the functional alcohols.

The polyurethanes are thermosetting polyurethanes that have a molecular weight that is calculated based on the molecular weight of polyol and isocyanates. The weight % of urethane linkage is defined as a known mole of urethane linkages per weight of thermosetting polyurethane. For each gram of thermoset polyurethane added to the reaction mixture, the number of moles of urethane linkages are known per weight of the thermoset polyurethane, and thus the amount of catalyst and functional alcohol is calculated according to the moles of urethan linkages in the thermoset polyurethane. The molecular weights of polyurethanes are generally well-defined in the polymer industry, and to determine the equivalence of urethane linkages for calculating amounts of base catalyst and functional alcohol would be determined according to the molecular structure of the polyurethane.

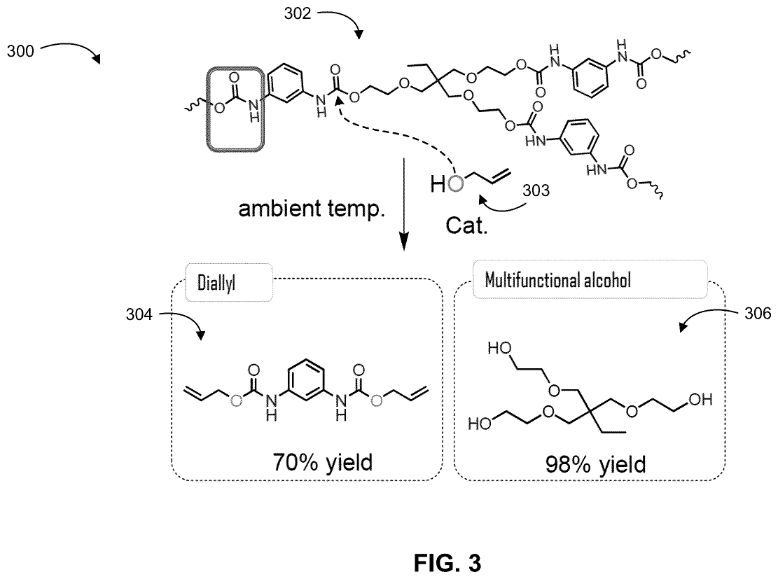

FIG. 3 illustrates the reaction 300 that results in the depolymerization of aromatic isocyanate urethanes. In one approach, an aromatic isocyanate urethane 302 is mixed with a functional alcohol, e.g., allyl alcohol, propargyl alcohol, etc. in the presence of a base catalyst. The reaction proceeds at ambient conditions at room temperature (e.g., no added heat) and atmospheric pressure (e.g., no added pressure). For example, there is no added pressure above atmospheric pressure nor any added heat above the temperature at the ambient conditions of the reaction. The resultant products include a diallyl urethane monomer 304 and a multi-functional alcohol 306.

The unsaturated groups of the preferred functional alcohols, e.g., allyl alcohol, propargyl alcohol, etc., provide functionality to the degraded end products. As illustrated in FIG. 3, the alcohol (—OH) of the allyl alcohol 303 participates in the reaction with the polyurethane 302 by a nucleophilic addition of the alcohol (—OH) at the carbonyl carbon to generate the two products, diallyl urethane monomer 304 and a multi-functional alcohol 306. The unsaturated group of the functional alcohols may provide some nucleophilicity to the alcohol. In other functional alcohol such as a mercaptoethanol, glycidol, vinyl alcohol, etc. the functional groups appeared to adversely affect the alcohol group such that the other functional alcohols did not have sufficient nucleophilic behavior (i.e., not a good nucleophile) to perform the reaction on the polyurethane. Alternatively, the other functional alcohols had increased sensitivity in the reaction mix and cause a side reaction to occur. Some functional alcohols do not form the desired end product from the reaction with polyurethanes.

Preferably, the functional alcohol is present in molar excess of the urethane linkages of the polyurethane. In preferred approaches, the functional alcohol includes at least one alcohol (—OH) group. The functional alcohol may be present in an amount where the number of —OH groups is about up to 10 times greater than the number of urethane linkages of the polyurethane in the reaction mixture. The product may include instructions for any of the foregoing.

The amount of a base catalyst may be in a ratio of 0.5 to 1 molar equivalent of a catalyst relative to a molar equivalent of urethane linkages of the polyurethane. Higher concentrations of a stronger base, e.g., NaOH, KOH, etc., may result in a reduced yield of desired end products. Alternatively, less strong bases may be present as a catalyst in a molar excess of the urethane linkages of the polyurethane. The product may include instructions for any of the foregoing.

Although adding heat to the reaction may increase the rate of degradation, there is a higher proportion of by-products produced by side-reactions in the reaction mixture. In one approach, heating the reaction mixture to 60° C. to increase the yield of reclaimed polyol using methanol. In an exemplary approach, the reaction mixture is maintained at ambient temperature (i.e., no added heat is provided) and no added pressure is provided and produces a high yield of the desired end products of a diallyl urethane monomer and a multi-functional alcohol. The reaction end products are essentially free of by-products produced by undesirable side-reactions.

Referring back to FIG. 2, operation 204 includes collecting a product from the mixture after a duration of time. The product includes a diallyl urethane monomer and a multi-functional alcohol. In an exemplary approach, the reaction produces end products being a diallyl urethane monomer and a multi-functional alcohol. The method includes converting polyurethane into end products being diallyl urethane monomer and a multi-functional alcohol. The end products may be identified by NMR, showing a yield in a range of 60 to 98%, where the yield is measured in terms of mol. % of urethane from starting material to end product having urethane functional groups. In one approach, a yield of the diallyl urethane monomer is greater than 60%. In one approach, a yield of the multi-functional alcohol is greater than 80%, where the yield is measured in terms of mol. % of alcohol functional group from starting alcohol to the end product of the alcohol functional group in the multi-functional alcohol. In preferred approaches, the product includes essentially no side-products.

In one approach, the duration of time is a predefined duration of time expected to reach a calculated or experimentally determined desired extent of reaction, to ensure a complete extent of reaction, etc. The duration of time may be in a range of time determined by experimentation to amount reach a desired amount of conversion of the polyurethane to desired end products. In another approach, the duration of time is a time period that extends beyond a predetermined minimum period of time. In yet another approach, the duration of time is determined during performance of the method 200, e.g., based on a sensor-derived analysis of the mixture for estimating an extent of reaction or related parameter during performance of the method, based on a (human or machine) visual inspection or similar inspection of the mixture during performance of the method, etc.

In various approaches, a duration of time may be in a range of greater than one hour up to 40 hours at room temperature. In preferably approaches, in larger batches, a duration of time may be in a range of greater than 6 hours to 40 hours at room temperature. In one example, components are mixed at room temperature with no added pressure, with a stirrer, polymer degrades for a duration of time equivalent to an overnight period, approximately 12 hours. In some approaches, a reaction is essentially complete after a duration of time that is about 20 hours of stirring at room temperature. In other approaches, the mixture may be stirred at room temperature up to 40 hours to make sure the reaction is complete.

Following completion of the reaction, the mixture includes the by-products, a diallyl urethane monomer and a multifunctional alcohol. Each by-product is present in the mixture in a substantially pure form; however, the mixture undergoes a further step of processing to isolate the by-products from each other. The by-products may be isolated using known techniques generally understood by one skilled in the art. In preferred approaches, the processing step may include aqueous wash and solvent evaporation. Expensive methods (e.g., column chromatography, ionic exchange, etc.) are not needed to separate the by-products.

The diallyl urethane monomer may be mixed with a thiol monomer for forming a photopolymer. In one approach, the diallyl urethane monomer may be mixed with a thiol monomer for printing a 3D part using light-based additive manufacturing processes, for example Pp SL techniques. The multi-functional alcohol is a high value end product that may be used to make polyurethanes, coatings, etc. The multi-functional alcohols may be used in a reaction with isocyanate (e.g., a multi-functional isocyanate) to synthesize a polyurethane product.

According to one aspect, the depolymerized diallyl urethane monomer may be combined with a thiol-ene monomer to form a photopolymer. In an exemplary approach, a photopolymer includes a thiol-ene network including urethane linkages. In one approach, the photopolymer has a mechanical toughness greater than 40 mJ/cm², a mechanical toughness that is about 50% greater than the mechanical toughness of thiol-ene-based photopolymers formed by conventional methods. In addition, the resultant photopolymers formed with depolymerized diallyl urethane monomers show superior mechanical properties compared to conventional photopolymers.

In one aspect, the method may include a further operation of using the diallyl urethane monomer, generated from the depolymerization of the polyurethane, in a reaction with a thiol-based monomer for synthesis of a photopolymer product. In one approach, the method may include a further operation of using the multi-functional alcohol, generated from the depolymerization of the polyurethane, in a reaction with isocyanate for synthesis of a polyurethane product.

Chemical recycling of polyurethane with functional alcohol may lead to diverse materials library through the appropriate re-formulation of the recycled allyl monomers. When mixing with commercially available thiol monomers, the recycled allyl monomers readily undergo fast photopolymerization with thiol functional groups. A 3D printed structure with high precision can be fabricated with the depolymerized monomers. The photopolymer formed by 3D printing may have a complex geometric shape, e.g., a gyroid shape, a complex structure with predefined arrangement of struts, etc.

In addition, a multi-functional alcohol product may be re-used in urethane synthesis without sacrifice to the performance of the reaction.

### Experiments

To evaluate the efficiency of polyurethane degradation with functional alcohol, allyl alcohol and propargyl alcohol were utilized to urethane degradation. A strong base, t-BuOK, was selected as the catalyst for the study. The crosslinked polyurethane networks completely depolymerized into a liquid monomer within 48 hours at ambient temperature. Table 1 lists the reaction yields. In general, functional alcohols show a 5× higher reaction yield compared to that of mono alcohols, e.g., methanol.

TABLE 1
Yield of urethane and polyol using methanol,
allyl alcohol, or propargyl alcohol

| | Catalyst | Urethane Yield (%) | Polyol Yield (%) |
|---|---|---|---|
| Methanol | T-BuOK | 18 | 30 |
| Allyl alcohol | T-BuOK | 68 | 98 |
| Propargyl alcohol | T-BuOK | 64 | 98 |

Table 2 lists the reaction yields of urethane and polyol using allyl alcohol with polyurethane and various base catalysts. T-BuOK at 0.5 to 2 equivalents (eq.) relative to equivalents of urethane linkages in the polyurethane generated high yield of urethane and polyol. Interestingly, 1 eq. of t-BuOK generated a higher yield of urethane monomer than 2 eq. of t-BuOK. NaOH catalyst generated a better yield or urethane monomer at 1 eq. than 2 eq. All reactions were conducted at ambient temperature and pressure.

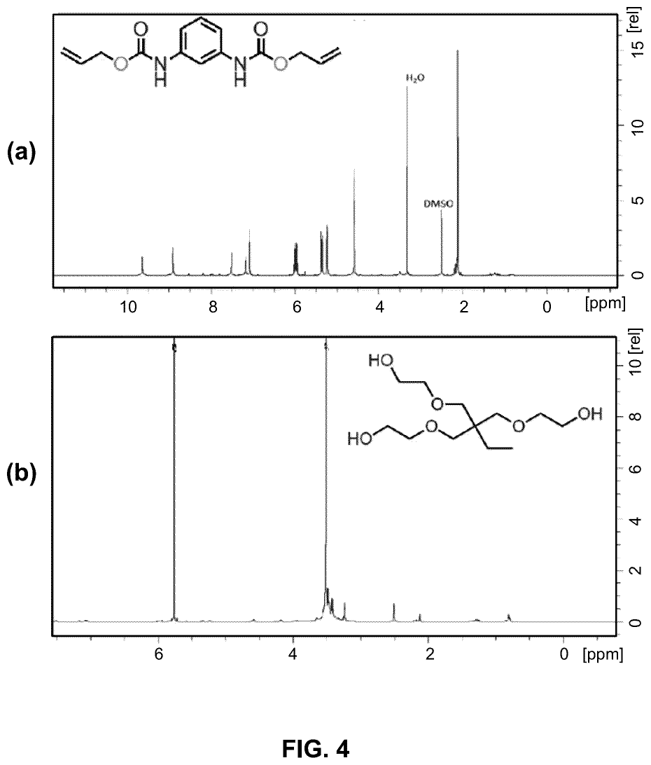

FIG. 4 depicts the NMR spectrum of the products from the reaction of polyurethane with allyl alcohol in the presence of a base catalyst. Part (a) is the NMR

TABLE 2
Effect of Catalysts on Urethane and Polyol Yields

| | Amount of Catalyst | Urethane | Polyol |
|---|---|---|---|
| Catalyst | (equivalent) | Yield (%) | Yield (%) |
| T-BuOK | 1 | 68 | 98 |
| NaOH | 1 | 59 | 90 |
| KOH | 1 | 44 | 95 |
| CsCO3 | 1 | 37 | 75 |
| T-BuONa | 1 | 50 | 81 |
| T-BuOK | 2 | 57 | 91 |
| T-BuOK | 0.5 | 54 | 100 |
| NaOH | 2 | 28 | 83 |
| NaOH | 0.5 | 43 | 70 |

spectrum of the diallyl urethane monomer and part (b) is the NMR spectrum of the multi-functional alcohol. The NMR spectrums show minimal by-product formation.

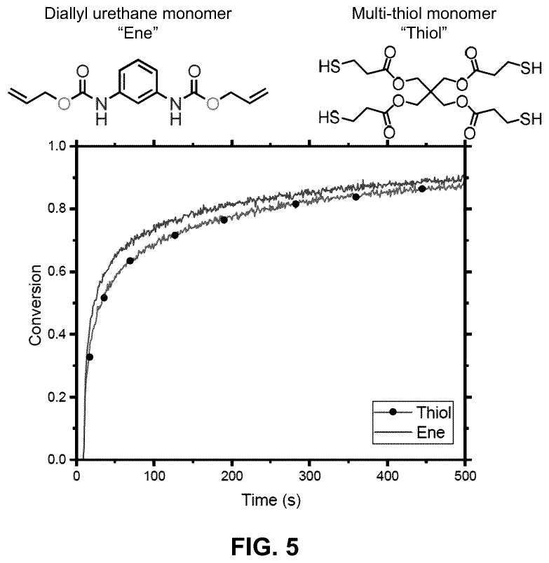

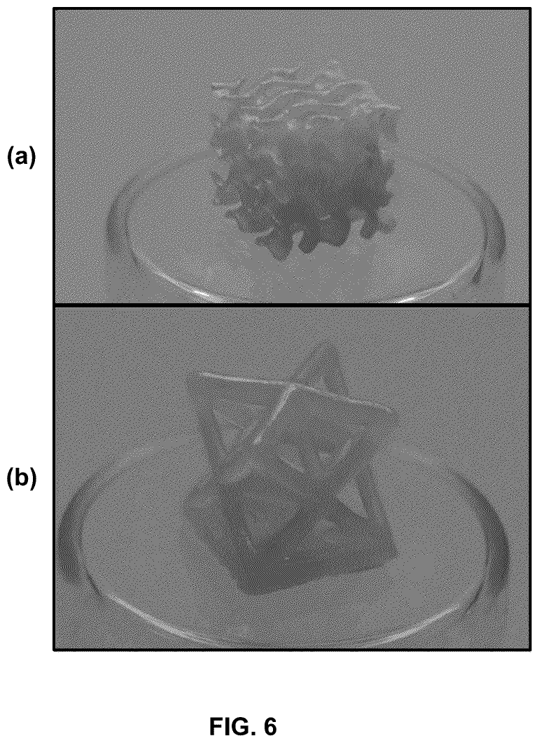

FIG. 5 represents a plot of the conversion of each of the two components, a diallyl urethane monomer “Ene” and a multi-thiol monomer “Thiol” (●) to form a polymer via light-mediated polymerization. The conversion of the two functional groups, (Ene and Thiol) to a polymerized product occurred in an equimolar fashion at a comparable rate. The depolymerized diallyl urethane monomer “Ene” functions comparable to the Thiol monomer to form a polymerized product. The reaction between the diallyl urethane monomer and the thiol to convert to a polymer occurs within 10 to 20 seconds of exposure to light (405 nm light). FIG. 6 depicts two images, part (a) and part (b), of complex geometric structures formed with the depolymerized diallyl urethane monomer and a thiol monomer. The printed structures have a predefined repeating complex pattern of spatially organized filaments. Part (a) depicts a gyroid-type structure, and part (b) depicts a structure having a predefined arrangement of struts. The structures were formed using light-mediated 3D printing techniques, such as PμSL.

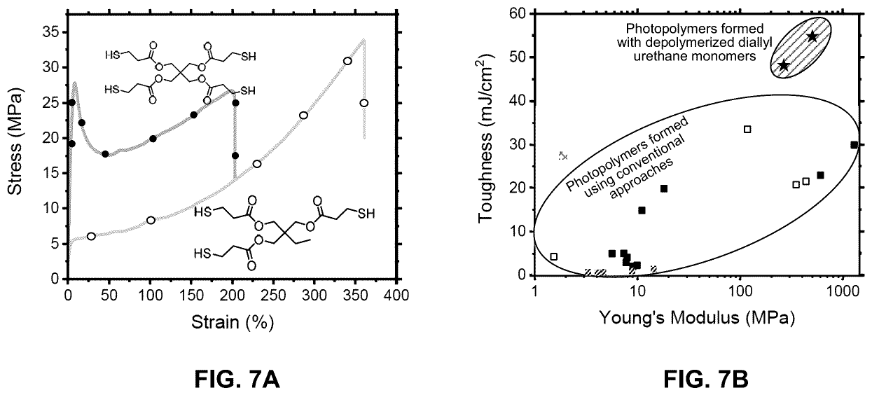

FIG. 7A depicts the mechanical properties of polymerized structures formed with the depolymerized diallyl urethane monomer and two different thiol monomers. The polymerized product formed with a thiol having 4 functional groups (●) demonstrated different mechanical properties to the polymerized product formed with a thiol having 3 functional groups (o). The mechanical properties of a polymerized product may be tuned according to the type of thiol monomer combined with the depolymerized diallyl urethane monomer.

FIG. 7B is a plot of the relative mechanical strength of the photopolymers formed with depolymerized diallyl urethane monomers (★) compared to thiolene-based photopolymers formed using conventional approaches (▪) in terms of Toughness (mJ/cm2) over Young's Modulus (MPa), where Toughness is defined as the area under the stress versus the strain curve (i.e., the energy that results in breaking the polymer material. Photopolymers tend to have weak mechanical properties, however, the addition of diallyl urethane monomers for forming thiol-ene based photopolymers (★) results in products having mechanical performance that is significantly higher than conventional thiolene-based photopolymers formed without urethane monomers (▪).

### In Use

Various aspects of an inventive concept described herein may be used by additive manufacturing manufacturers, chemical manufacturers, vehicle manufacturers, etc.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. A product, comprising:
a mixture for converting a polyurethane, the mixture comprising:
a functional alcohol, and
a catalyst.

2. The product as recited in claim 1, wherein the functional alcohol is selected from the group consisting of: an allyl alcohol, a propargyl alcohol, a glycidol, an allyl amine alcohol, and a propargylamine alcohol.

3. The product as recited in claim 1, wherein the catalyst is a base catalyst.

4. The product as recited in claim 1, wherein the mixture is configured to convert a polyurethane having at least one urethane linkage, wherein the mixture is characterized as causing a reaction with the polyurethane upon addition of the mixture to the polyurethane to thereby form a secondary product that includes a diallyl urethane monomer and a multi-functional alcohol.

5. The product as recited in claim 4, where in the polyurethane is a rigid polyurethane material.

6. The product as recited in claim 4, wherein the polyurethane includes an aromatic isocyanate-based urethane.

7. The product as recited in claim 4, wherein the functional alcohol includes at least one —OH group, wherein the product includes instructions to add an amount of the mixture to the polyurethane such that the functional alcohol is present in molar excess of the number of urethane linkages of the polyurethane.

8. The product as recited in claim 4, wherein the product includes instructions to add an amount of the mixture to the polyurethane such that the catalyst is present in a ratio of 0.5 to 1 molar equivalent of the catalyst relative to a molar equivalent of urethane linkages.

9. A method of converting polyurethane, the method comprising:
forming a mixture at an ambient temperature, the mixture comprising: a polyurethane, a functional alcohol, and a catalyst; and
collecting a product from the mixture after a duration of time, wherein the product includes a diallyl urethane monomer and a multi-functional alcohol.

10. The method as recited in claim 9, the catalyst includes a base catalyst.

11. The method as recited in claim 9, wherein the method does not include providing added heat.

12. The method as recited in claim 9, wherein the method does not include providing added pressure.

13. The method as recited in claim 9, wherein a yield of the diallyl urethane monomer is greater than 60%.

14. The method as recited in claim 9, wherein a yield of the multi-functional alcohol is greater than 80%.

15. The method as recited in claim 9, wherein the product include essentially no side-products.

16. The method as recited in claim 9, further comprising using the diallyl urethane monomer in a reaction with a thiol-based monomer for synthesis of a photopolymer product.

17. The method as recited in claim 9, further comprising using the multi-functional alcohol in a reaction with isocyanate for synthesis of a polyurethane product.

18. A photopolymer, comprising:
a thiol-ene network comprising urethane linkages.

19. The photopolymer as recited in claim 18, wherein the photopolymer has a mechanical toughness greater than 40 mJ/cm².

20. The photopolymer as recited in claim 18, wherein the photopolymer is a 3D printed product having a complex geometric shape.
